(19) United States
(12) Patent Application Publication
(10) Pub. No.: US 2026/0126558 A1
(43) Pub. Date: May 7, 2026

(54) NEURAL NETWORK FOR AUTOMATED MICROSEISMIC DETECTION AND LOCATION

(71) Applicant: Board of Regents, The University of Texas System, Austin, TX (US)

(72) Inventor: Hongyu Sun, El Paso, TX (US)

(21) Appl. No.: 19/369,710

(22) Filed: Oct. 27, 2025

Related U.S. Application Data
(60) Provisional application No. 63/715,422, filed on Nov. 1, 2024.

(51) Int. Cl. G01V 1/30

(52) U.S. Cl. CPC G01V 1/305; G01V 2210/38

(57) ABSTRACT

A computer implemented method for detecting and locating microseismic events is provided. The method comprises using a processor set to receive a dataset from a number of real stations. The dataset comprises information associated with seismic signals in a time period. The processor set trains a neural network comprising a number of neural operators using the dataset. The number of neural operators comprise a combination of neural operator layers for identifying temporal-spatial information associated with the seismic signals in the time period. The neural network further comprises a classification model and a regression model. The classification model and the regression model are trained using the dataset and the temporal-spatial information associated with the seismic signals in the time period. The processor set detects and locates a number of seismic events using the trained neural network.

### CROSS-REFERENCE TO RELATED APPLICATION

This application claims the benefit of U.S. Provisional Patent Application Ser. No. 63/715,422, filed Nov. 1, 2024, and entitled “Automated Microseismic Detection and Location with Quake Neural Operator,” which is incorporated herein by reference in its entirety.

### BACKGROUND INFORMATION

### 1. Field

The present disclosure relates generally to a neural network for automated microseismic detection and location.

### 2. Background

Seismic events are occurrences that generate vibrations or waves propagating through the Earth. Seismic events are typically caused by sudden energy releases within the crust or upper mantle. These events can include natural phenomena such as earthquakes, volcanic eruptions, or human-induced activities like explosions, reservoir-induced tremors, and mining operations.

Microseismic events are similar in nature but involve much smaller energy releases that often go unnoticed at the surface. Microseismic events occur on a micro scale, usually producing very weak vibrations that can only be detected by sensitive instruments placed close to the source. In this case, microseismic events can arise naturally from minor rock stress adjustments or be triggered by human activities such as hydraulic fracturing or underground excavation.

### SUMMARY

An illustrative embodiment provides a computer-implemented method. The method comprises using a processor set to receive a dataset from a number of real stations. The dataset comprises information associated with seismic signals in a time period. The processor set trains a neural network comprising a number of neural operators using the dataset. The number of neural operators comprise a combination of neural operator layers for identifying temporal-spatial information associated with the seismic signals in the time period. The neural network further comprises a classification model and a regression model. The classification model and the regression model are trained using the dataset and the temporal-spatial information associated with the seismic signals in the time period. The processor set detects a number of seismic events using the trained neural network.

Another illustrative embodiment provides a computer system. The system comprises a processor set, a set of one or more computer-readable storage media, and program instructions stored on the set of one or more storage media to cause the processor set to perform operations comprising receiving a dataset from a number of real stations, where the dataset comprises information associated with seismic signals in a time period; training a neural network comprising a number of neural operators using the dataset, where the number of neural operators comprise a combination of neural operator layers for identifying temporal-spatial information associated with the seismic signals in the time period, where the neural network further comprises a classification model and a regression model, and the classification model and the regression model are trained using the dataset and the temporal-spatial information associated with the seismic signals in the time period; and detecting a number of seismic events using the trained neural network.

Another illustrative embodiment provides a computer program product. The computer program product comprises a set of one or more computer-readable storage media, and program instructions stored in the set of one or more storage media to perform operations comprising using a processor set to receive a dataset from a number of real stations, where the dataset comprises information associated with seismic signals in a time period; training a neural network comprising a number of neural operators using the dataset, where the number of neural operators comprise a combination of neural operator layers for identifying temporal-spatial information associated with the seismic signals in the time period, where the neural network further comprises a classification model and a regression model, and the classification model and the regression model are trained using the dataset and the temporal-spatial information associated with the seismic signals in the time period; and detecting a number of seismic events using the trained neural network.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a seismic data management system in accordance with an illustrative embodiment;

FIG. 3 depicts an architecture for a neural network for detecting microseismic events in accordance with an illustrative embodiment;

FIGS. 4A-4B depict waveforms for two seismic events received from real stations in accordance with an illustrative embodiment;

FIGS. 5A-5B depicts virtual stations and noise data assigned to the virtual stations in accordance with an illustrative embodiment;

FIG. 6 depicts illustrations of graph construction for the graph neural operator layers in accordance with an illustrative embodiment;

FIGS. 7A-7D depicts a plot of probability for a microseismic event with different signal-to-noise ratio and a plot of location error in accordance with an illustrative embodiment;

FIG. 8 depicts a flowchart illustrating a process for detecting seismic events in accordance with an illustrative embodiment;

FIG. 9 depicts a flowchart illustrating a process for detecting seismic events in accordance with an illustrative embodiment;

FIG. 10 depicts a flowchart illustrating a process for recording data for seismic events in accordance with an illustrative embodiment;

FIG. 11 depicts a flowchart illustrating a process for introducing noise data to the training dataset in accordance with an illustrative embodiment; and

FIG. 12 is a block diagram of a data processing system in accordance with an illustrative embodiment.

### DETAILED DESCRIPTION

The illustrative embodiments recognize and take into account a number of considerations. For example, the illustrative embodiments recognize and take into account that each type of seismic event produces distinct waveforms that can be recorded by seismometers, allowing scientists to analyze their origin, magnitude, and depth.

The illustrative embodiments recognize and take into account that monitoring microseismic events helps in tracking subsurface stress changes, mapping fracture networks, and ensuring the stability and safety of engineered underground environments.

The illustrative embodiments recognize and take into account that microseismic detection focuses on capturing and analyzing very small-scale seismic events that are often too weak to be felt by humans.

Thus, illustrative embodiments of the present invention provide a computer implemented method, computer system, and computer program product for detecting microseismic events. The method comprises using a processor set to receive a dataset from a number of real stations. The dataset comprises information associated with seismic signals in a time period. The processor set trains a neural network comprising a number of neural operators using the dataset. The number of neural operators comprise combinations of neural operator layers for identifying temporal-spatial information associated with the seismic signals in the time period. The neural network further comprises a classification model and a regression model. The classification model and the regression model are trained using the dataset and the temporal-spatial information associated with the seismic signals in the time period. The processor set detects a number of seismic events using the trained neural network.

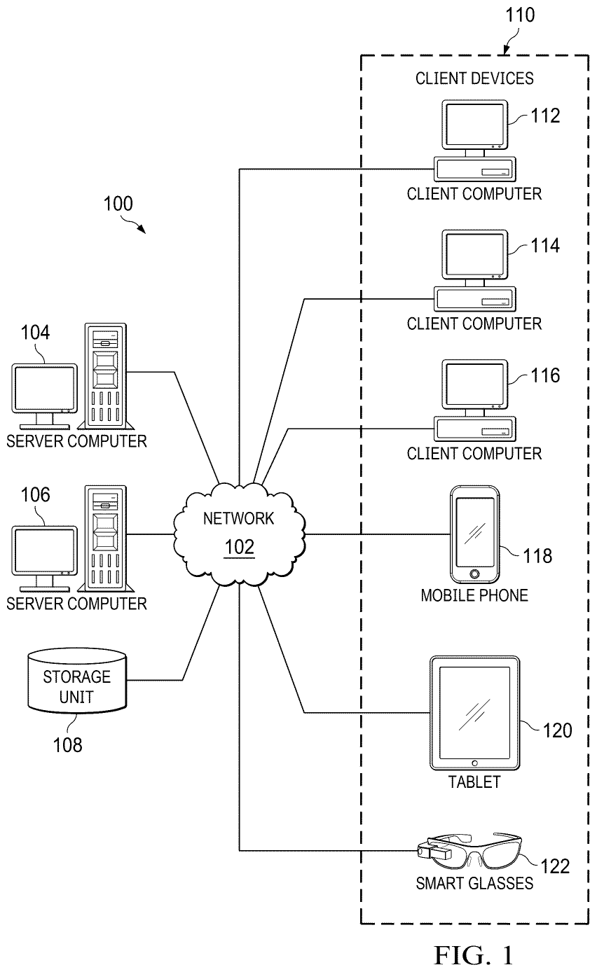

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wired, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

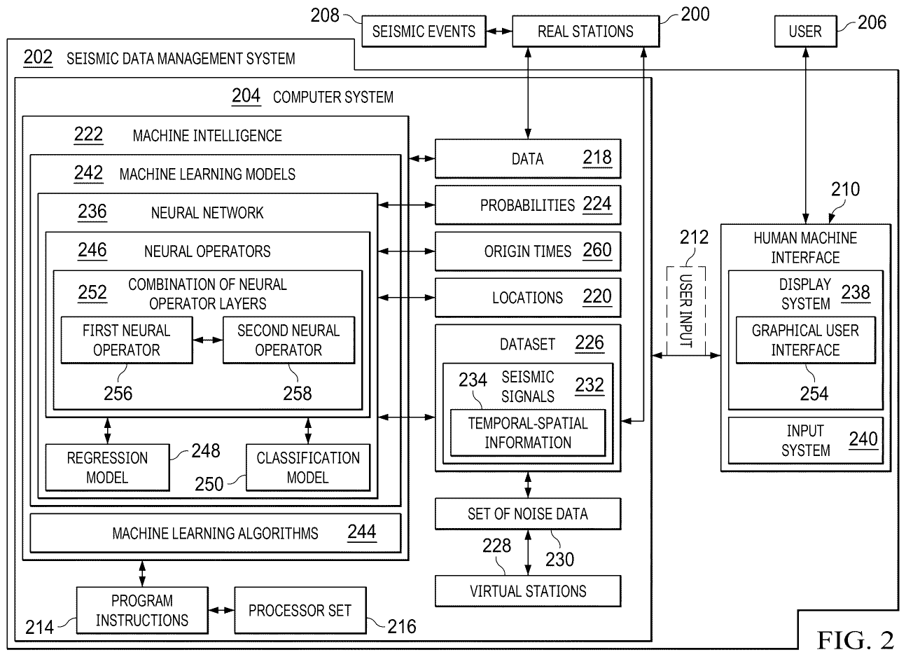

With reference now to FIG. 2, an illustration of a block diagram of a seismic data management system is depicted in accordance with an illustrative embodiment. In this illustrative example, seismic data management system 202 includes components that can be implemented in hardware such as the hardware shown in network data processing system 100 in FIG. 1.

In this illustrative example, seismic data management system 202 trains neural network 236 from machine intelligence 222 in computer system 204 and uses neural network 236 for detecting seismic events and microseismic events such as a number of seismic events 208.

As depicted, seismic events are occurrences that generate vibrations or waves propagating through the Earth due to a sudden release of energy within the crust or mantle. These events can arise naturally such as from earthquakes, volcanic eruptions, or landslides, or be induced by human activities like mining, explosions, or fluid injection. Seismic events generate distinct waveforms that include P waves and S waves that through the Earth and are recorded by seismic stations such as real stations 200. In this example, seismic stations such as real stations 200 are monitoring sites equipped with instruments that record ground vibrations produced by natural or human-induced seismic events. Each seismic station usually contains one or more seismometers or geophones that measure ground motion in multiple directions and convert it into electrical signals representing the Earth's movement over time.

Microseismic events are smaller-scale versions of seismic events that typically involve much lower energy releases that are too weak to be felt on the surface. Because seismic signals for microseismic events are faint, detecting them requires highly sensitive instruments and dense monitoring networks placed close to the source area. However, microseismic events still provide valuable information about subsurface deformation, fracture development, and stress distribution despite their small size. In some illustrative examples, microseismic events can also be considered as seismic events.

In this illustrative example, seismic data management system 202 includes machine intelligence 222 that can be implemented in software, hardware, firmware, or a combination thereof. When software is used, the operations performed by machine intelligence 222 or components of machine intelligence 222 can be implemented in program instructions configured to run on hardware, such as a processor unit. When firmware is used, the operations performed by machine intelligence 222 can be implemented in program instructions and data and stored in persistent memory to run on a processor unit. When hardware is employed, the hardware can include circuits that operate to perform the operations in machine intelligence 222.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 216 in FIG. 2. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 also includes machine intelligence 222. Machine intelligence 222 can include machine learning models 242 and machine learning algorithms 244. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 222 is continuously refined over time through trial and error. Equivalence of assets or products can be effectively performed by supervised machine learning, unsupervised learning, semi-supervised learning, and reinforcement learning so that products or assets that do not match descriptively can nevertheless be matched. Over time, the data model from machine learning can provide a greater degree of flexibility in matching machine intelligence 222.

Machine intelligence 222 can be implemented using one or more systems such as an artificial intelligence system, a neural network, a generative neural network, a Bayesian network, an expert system, a fuzzy logic system, a genetic algorithm, or other suitable types of systems. Machine learning models 242 and machine learning algorithms 244 may make computer system 204 a special purpose computer for training neural network 236 from machine learning models 242 and detecting seismic events such as seismic events 208.

Machine learning models 242 involves using machine learning algorithms 244 to build computation models based on samples of data. The samples of data used for training are referred to as training data or training datasets. Machine intelligence 222 can make predictions without being explicitly programmed to make these predictions. Machine intelligence 222 can be used for training and retraining computation models for a number of different types of applications. These applications include, for example, medicine, financial services, healthcare, speech recognition, computer vision, or other types of applications.

In this illustrative example, machine learning models 242 can include a number of models. For example, machine learning models 242 can include a deep learning model such as neural network 236. In this illustrative example, neural network 236 is a type of machine learning model that is composed of layers of interconnected units called neurons or nodes, which work together to recognize patterns, make predictions, or approximate complex relationships in data. Each neuron receives input values, applies a mathematical transformation, and passes the result to other neurons in the next layer. In this example, neural network 236 can learn by adjusting the connection weights between neurons during training, using large datasets and optimization algorithms to minimize prediction errors. In other words, neural network 236 is a flexible computational framework designed to automatically learn patterns and decision rules directly from examples.

In this illustrative example, machine learning algorithms 244 can include supervised machine learning algorithms, semi-supervised machine learning algorithms, reinforcement machine learning algorithms, and unsupervised machine learning algorithms. Supervised machine learning can train machine learning models using data containing both the inputs and desired outputs. Examples of machine learning algorithms include XGBoost, neural networks such as attention network, transformers, or any suitable neural networks, K-means clustering, and random forest.

In this illustrative example, neural network 236 can be trained using dataset 226 collected from seismic stations such as real stations 200. In this example, dataset 226 includes information associated with seismic signals 232 in a time period.

In this illustrative example, neural network 236 in computer system 204 can include neural operators 246. In this example, neural operators 246 are computational architecture for neural network 236 that learn how one function changes into another. In this illustrative example, neural operators 246 learn general rules that describe how entire patterns or fields are related. This allows neural operators 246 to predict outcomes for new situations without needing to see every example.

In this example, neural operators 246 include at least combination of neural operator layers 252 for identifying temporal-spatial information 234 associated with seismic signals 232 collected by real stations 200 in the time period. In this illustrative example, temporal-spatial information 234 is information of waveforms, locations, and times for seismic events and microseismic events associated with seismic signals 232.

In this illustrative example, combination of neural operator layers 252 can include first neural operator 256 and second neural operator 258. In this example, first neural operator 256 can be configured for processing temporal features from seismic signals 232 and second neural operator 258 can be configured for processing spatial features from seismic signals 232. In other words, first neural operator 256 and second neural operator 258 are trained using temporal-spatial information 234 associated with seismic signals 232 such that neural operators 246 can be used for extracting temporal-spatial information from seismic signals associated with future seismic events and neural network 236 can be used for detecting future seismic events in response to receiving additional seismic signals. In this illustrative example, it should be understood that “first” and “second” in first neural operator 256 and second neural operator 258 do not intend to imply orders of operations, instead they are merely for the purpose of distinguishing neural operators. In other words, in some other illustrative examples, first neural operator 256 can be configured for processing spital features from seismic signals 232 while second neural operator 258 can be configured for processing temporal features from seismic signals 232.

In this illustrative example, neural network 236 further includes regression model 248 and classification model 250. In this illustrative example, regression model 248 and classification model 250 can serve as a projection layer of neural network 236. Regression model 248 and classification model 250 are also trained using dataset 226 and temporal-spatial information 234. In this example, classification model 250 can be trained for predicting possibilities of seismic events and microseismic events and regression model 248 can be trained for identifying time and locations of the seismic events and microseismic events.

In this example, the loss function for training regression model 248 and classification model 250 can be a cumulative loss function that uses a weighted sum of the individual task losses:

$${ℒ}_{total} = {ℒ}_{class} + α {ℒ}_{r e g} \qquad ( 1 )$$

where a is a weight that balances the contribution of the regression task relative to the classification task; [symbol] _{class} is the loss for classification model 250 and [symbol] _{reg} is the loss for regression model 248. In this example, the cross-entropy loss function for the classification task is an expectation over joint distribution (X, Y)˜D₁, where X=f(t; x, y, z) representing the input data and Y=[Y^{signal}, Y^{noise}] representing the true labels. In this example, [symbol] _{class} can be reformulated as:

$${ℒ}_{class} = {𝔼}_{( X , Y ) ∼ {D}_{1}} [ - {\sum }_{i = 1}^{n} ( {Y}_{i}^{signal} log {p}_{i}^{signal} + {Y}_{i}^{n o i s e} log {p}_{i}^{noise} ) ] \qquad ( 2 )$$

In addition, the regression task uses mean squared error to predict the time and location of seismic events and microseismic events. For example, [symbol] _{reg} can be reformulated as:

$${ℒ}_{r e g} = {𝔼}_{( X , {r}_{t r u e} ) ∼ {D}_{2}} [ {( \hat{x} - {x}_{true} )}^{2} + {( \hat{y} - {y}_{true} )}^{2} + {( \hat{z} - {z}_{true} )}^{2} + {( \hat{t} - {t}_{true} )}^{2} ] \qquad ( 3 )$$

In this illustrative example, dataset 226 can further include set of noise data 230. Microseismic detection becomes difficult when noise is high because the weak signals from microseismic events can easily be masked or distorted by stronger background vibrations. In this example, microseismic waves have very low amplitude and it is difficult to distinguish real event signals from random fluctuations.

In this illustrative example, set of noise data 230 can include real noise data collected by real stations 200 and real data or synthetic data generated for virtual stations 228. In this illustrative example, virtual stations 228 are representations of virtual seismic stations for real noise data to enrich training data such as dataset 226 for neural network 236. In this example, waveforms from both virtual station 228 and real station 200 can be preprocessed by removing the trend and applying an appropriate bandpass filter to retain the signal of interest. Subsequently, the data can be normalized to ensure consistent amplitude scaling across channels

In this illustrative example, virtual stations 228 can be generated with random locations within an area defined based on locations of real stations 200 and assigned with noise waveforms to simulate real noise data. In this example, introduction of set of noise data 230 to dataset 226 makes the training of neural network 236 more focused on detecting seismic events and microseismic events when noise is high. As a result, neural network 236 can be used for efficiently detecting microseismic events, especially when noise is high. In this example, set of noise data 230 is inserted into dataset 226 for training purposes.

In this example, neural operators 246 in neural network 236 are trained using segments of data from dataset 226. In this illustrative example, each segment of data from the segments of data corresponds to data from a sliding time window for the dataset. In this example, the sliding time window can be a pre-defined duration that ranges from 10 seconds to 60 seconds. It should be understood that segments of data can include overlapping data from dataset 226. For example, a segment of data can include data from second “0” to second “15”, while another segment of data can include data from second “10” to second “25”.

In this illustrative example, the window length of 10 seconds to 60 seconds is appropriate for local microseismic monitoring where waves decay fast during propagation. A short time frame also reduces the possibility of the existence of multiple events in one sample. Similar to other waveform-based earthquake location algorithms, neural network 236 faces the challenge of handling multiple events within a single input time window. The algorithm may focus on seismic events with larger magnitudes while overlooking the other when two seismic events occur in the same sample. Thus, the selection of a short sliding time window is a straightforward way to address this issue and is particularly effective for microseismic monitoring, where the interevent time is generally much longer than the aftershocks of large earthquakes. Moreover, the use of overlapping time windows when processing continuous data also helps to reduce the possibility of missing events.

In this illustrative example, a computational domain that covers locations of the earthquake and seismic stations can be defined for virtual stations 228. In this illustrative example, the physical lower bounds of longitude λ₀ and latitude φ₀ can be:

$${λ}_{0} = \frac{{λ}_{max} + {λ}_{min}}{2} - \frac{d}{2} \qquad ( 4 )$$

$${ϕ}_{0} = \frac{{ϕ}_{max} + {ϕ}_{min}}{2} - \frac{d}{2} \qquad ( 5 )$$

where λₘₐₓ is the maximum longitude, λₘᵢₙ is the minimum longitude, φₘₐₓ is the maximum latitude, φₘᵢₙ is the minimum latitude of all seismic stations around a seismic event or a microseismic event. Each sample is mapped with a varying center so that all seismic stations in the graph are around the middle of the computational domain. In addition, d represents the extent of the computational domain on the Earth's surface.

In this example, the chosen range “d” should be large to encompass all seismic stations within the graph. Since the propagation range of microseismic events are typically short, a selection of d=1.2° is sufficient and appropriate for monitoring local earthquakes. After determining the physical lower bounds of the computational domain, the relative position of each station within this domain can be calculated using:

$${x}_{i} = \frac{{λ}_{i} - {λ}_{0}}{d} \qquad ( 6 )$$

$${y}_{i} = \frac{{ϕ}_{i} - {ϕ}_{0}}{d} \qquad ( 7 )$$

$${z}_{i} = \frac{{η}_{i} - {η}_{min}}{{η}_{max} - {η}_{min}} \qquad ( 8 )$$

where λᵢ, φᵢ, and ηᵢ are respectively the longitude, latitude, and depth of the i-th seismic station. ηₘₐₓ is the maximum depth and ηₘᵢₙ is the minimum depth of the computational domain. For example, a ηₘᵢₙ of “−4 km” and a ηₘₐₓ of “36 km” can be selected to cover depth of all seismic events in dataset 226. In this illustrative example, “0 km” corresponds to the sea level, which is used as reference point for depth. In this example, the computational domain and the relative positions (xᵢ, yᵢ, zᵢ) of the seismic stations are computed independently for each data sample during model training. For real world scenarios, the relative positions are computed only once for a given seismic network. These transformed coordinates are treated as node attributes and three additional channels of the input, along with the three-component waveform information.

In a similar fashion, the regression label for location of seismic events is the seismic events' relative location (xₜᵣᵤₑ, yₜᵣᵤₑ, zₜᵣᵤₑ) on the computational domain:

$${x}_{true} = \frac{Λ - {λ}_{0}}{d} \qquad ( 9 )$$

$${y}_{true} = \frac{Φ - {ϕ}_{0}}{d} \qquad ( 10 )$$

$${z}_{true} = \frac{H - {η}_{min}}{{η}_{max} - {η}_{min}} , \qquad ( 11 )$$

where (Λ, Φ, H) is the catalog location of the seismic events. The time predicted by neural operators 246 is the occurrence time of an event relative to the starting of input time series. Assuming the origin time T is within a range of 10 seconds earlier (tₘᵢₙ=−10s) and 10 seconds later (tₘₐₓ=10 s) than the starting time of an input waveform, the time “tₜᵣᵤₑ” of the regression label for training neural operators 246 should be:

$${t}_{true} = \frac{T - {t}_{min}}{{t}_{max} - {t}_{min}} \qquad ( 12 )$$

In this example, neural network 236 can be used for detecting seismic events and microseismic events such as seismic events 208. In this illustrative example, a set of real stations from real stations 200 can collect data 218 that are associated with seismic events 208. For example, data 218 can include seismic signals such as waveforms that are associated with seismic events 208. In this example, a set of real stations can be at least a portion of real stations from real stations 200.

As depicted, neural network 236 can extract temporal-spatial information using combination of neural operator layers 252 and uses regression model 248 and classification model 250 to process the extracted temporal-spatial information. As depicted, classification model 250 can be used to determine probabilities of seismic events and microseismic events happening. In addition, regression model 248 can be used to identify times and locations of the seismic events and microseismic events.

For example, neural network 236 can receive data 218 and uses classification model 250 to determine probabilities 224 for seismic events 208. In this example, each probability from probabilities 224 represents a likelihood of seismic events or microseismic events such as seismic events 208 happening based on seismic signals received from each real station. In other words, each probability from probabilities 224 represents a likelihood of actual detection of seismic events 208 by a real station from real stations 200.

In this illustrative example, neural network 236 simultaneously identifying locations 220 and origin times 260 for seismic events 208 using regression model 248. It should be noted that locations 220, origin times 260, and probabilities 224 are not the only parameters determined for seismic events 208. For example, neural network 236 can also be used to determine other parameters such as magnitude and time for seismic events 208.

In this example, a number of thresholds can be used to determine whether information for seismic events 208 should be saved in a catalog. In this illustrative example, a process can be used to determine whether a probability determined for each real station from real stations 200 exceeds a first threshold. In this example, at least a portion of real stations from the set of real stations 200 are associated with probabilities that exceed the first threshold. Subsequently, a number or a count of stations for the portion of real stations is compared to a second threshold. In response to determining that the number or the count for the portion of real stations exceeds the second threshold, at least locations 220 and time for seismic events 208 are stored in a catalog for recorded seismic events.

In this illustrative example, users such as user 206 can interact with computer system 204 through user inputs to computer system 204. For example, computer system 204 can receive user input 212 that includes the definitions of the first threshold and the second threshold as depicted above.

In this illustrative example, user input 212 can be generated by user 206 using human machine interface (HMI) 210. As depicted, human machine interface 210 includes display system 238 and input system 240. Display system 238 is a physical hardware system and includes one or more display devices on which graphical user interface 254 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 254 through user input 212 generated by input system 240. Input system 240 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view locations 220 and probabilities 224 determined for seismic events 208.

In the illustrative example, computer system 204 can be configured to perform at least one of the steps, operations, or actions described in the different illustrative examples using software, hardware, firmware, or a combination thereof. As a result, computer system 204 operates as a special purpose computer system in which neural network 236 in computer system 204 enables detection of seismic events and microseismic events, especially when noise is high. In particular, neural network 236 transforms computer system 204 into a special purpose computer system as compared to currently available general computer systems that do not have neural network 236.

In the illustrative example, the use of neural network 236 in computer system 204 provides a multi-task learning framework that integrates one classification task for seismic events detection and one regression task for locations of seismic events. In this illustrative example, both tasks are jointly addressed by sharing the underlying neural operator structures that effectively solve the seismic monitoring problem where earthquake detection and location are closely correlated. By combining first neural operator 256 for temporal feature extraction and second neural operator 258 for spatial information exchange, neural network 236 can efficiently handle the complex structure of seismic network data. Furthermore, neural network 236 can process seismic data from networks with varying geometries while maintaining a fixed model architecture.

Additionally, unlike other multi-station algorithms that fully encode seismic waveforms at each individual station before exchanging information among stations, neural network 236 facilitates communication among stations throughout the entire data flow within the neural operator. The sequential connection of first neural operator 256 and second neural operator 258 along with the repeated application of these layers ensures a comprehensive exchange of spatiotemporal information, which enhances seismic events detection and location accuracy, especially when noise is high.

In this illustrative example, existing techniques such as picking-based algorithms identify seismic arrivals from continuous data and then associate these picks with seismic events. Typically, a minimum number of picks is set as a hyperparameter and any association results with fewer picks than this threshold are filtered out. However, microseismic events can easily be filtered out because only a few clear picks are detected across the seismic network for microseismic events. The microseismic events recorded on many stations do not exhibit clear onsets for picking.

On the other hand, neural network 236 searches for the waveform information of a seismic event across multiple stations without picking and thus can detect small-scale events effectively. At the same time, the location of these events is determined based on waveform information rather than solely on arrival times, thereby reducing potential location errors due to post-processing steps.

In this illustrative example, illustrative embodiments of the present invention can automatically build an earthquake catalog containing at least the origin time and location information of each event, where the earthquake catalog can be built directly from continuous waveform data in an end-to-end manner without relying on phase picking. This differs from the traditional sequential workflow, which involves phase picking, phase association, and then event location.

The illustration of seismic data management system 202 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, data 218 can be a portion of dataset 226 and seismic events 208 can be associated with seismic signals 232 in dataset 226.

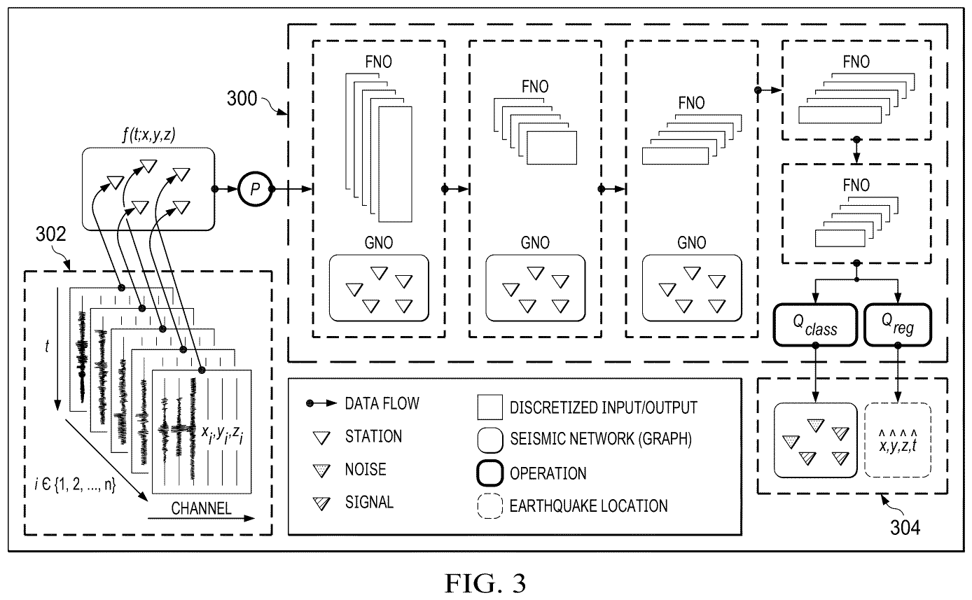

With reference now to FIG. 3, a diagram of architecture for a neural network for detecting microseismic events is shown in accordance with an illustrative embodiment. In this example, architecture 300 shown in FIG. 3 can be examples of neural network 236 in FIG. 2.

In FIG. 3, architecture 300 uses a multi-task learning framework with one classification for microseismic detection and one regression task for locations of microseismic events. In this illustrative example, inputs 302 includes a seismic wavefield of time and coordinates in the form of f(t;x,y,z) recorded by multiple real stations along with their arbitrary locations in the form of (xᵢ,yᵢ,zᵢ). In this illustrative example, inputs 302 can be used as training data such as dataset 226 in FIG. 2 or seismic signals data such as data 218 in FIG. 2.

In this illustrative example, inputs 302 can be fed into architecture 300 with combination of neural operator layers that include Fourier neural operator (FNO) and Graph Neural Operator (GNO). In this illustrative example, FNO learns global correlations in the time axis using Fourier transforms to effectively capture long-range dependencies in the data, which can be used for determining the probability of microseismic events. In addition, GNO operates on graph structures to model relationships among the real stations, which effectively deals with the irregular sampling of seismic data in the spatial domain. In this illustrative example, FNO can be an example of first neural operator 256 in FIG. 2 and GNO can be an example of second neural operator 258 in FIG. 2.

In this example, architecture 300 can be viewed as a series of mappings through layers of operation:

$$h = {FNO}_{k + 2} ∘ {FNO}_{k + 1} ∘ {GNO}_{k} ∘ FN {O}_{k} ∘ … ∘ {GNO}_{1} ∘ {FNO}_{1} ∘ P ( f ( t ; x , y , z ) ) \qquad ( 13 )$$

where ∘ denotes the mapping between the i-th layer to the (i+1)-th layer. For example, architecture 300 shows three combinations of layers of FNO and GNO. In this example, input 302 is first passed through an up-projection layer P, which maps the input function to a higher-dimensional space for better representation. Subsequently, the up-projected data is then passed through three combinations of FNO and GNO layers to allow for sufficient exchange of information between the time and space domains. The final output h from the shared part branches into two separate parts for classification and regression, respectively. In this illustrative example, both the classification task (Q_{class}) and the regression task (Q_{reg}) use two fully connected layers to generate output 304, which contains the probability of microseisimic events associated with signals from input 302 and the locations of the microseisimic events.

In this example, each FNO layer performs a 1-D spectral convolution along a time axis by performing a Fourier transform to the per-station features and multiplies the lowest Mₖ temporal modes by learned complex weights while zeroing higher modes, then inverse-transforms data back to the time domain and combines the result with a pointwise (1×1) linear projection, followed by a nonlinearity. In this example, each FNO layer retains only the first Mₖ lowest-frequency modes, as high-frequency components are more difficult to learn and are truncated during training.

In this illustrative example, the number of modes in each FNO layer is 24, 12, 8, 8, and 8, respectively. The width or channel number of the discretized function at each node varies with the dimension. Across the FNO layers, the per-station discretized representation v(t; xᵢ)∈R^{Ck×Tk}, with xᵢ=(xᵢ, yᵢ, zᵢ), takes the following shapes by layer: 48×1500, 96×500, 192×100, 192×50, and 24×50, where the first dimension is the channel width Cₖ and the second dimension is the number of time samples Tr. As the network progresses through downsampling, the number of Fourier modes Mₖ is reduced in proportion to the compressed resolution while the channel dimensions are increased to enrich feature representations. Nonlinearity is introduced in all FNO layers using the Gaussian Error Linear Unit, which applies a smooth, probabilistic gating mechanism that approximates the input multiplied by the cumulative distribution function of a standard normal distribution. The output of the last FNO layer is flattened into 1200 channels before feeding into Q_{class} and Q_{reg}.

On the other hand, at each GNO layer, real stations are treated as nodes of a graph constructed in the input spatial domain using a geographic distance threshold D, which indicates that two stations are connected if their pairwise distance≤D. In this example, the geographic distance threshold D can be set as 40 km. In this example, per-station temporal features v(t; xᵢ)∈R^{Ck×Tk} produced by the preceding FNO layer serve as node features. For each edge (i, j), an edge message is computed by a differentiable map φ that takes the two node features concatenated along the channel axis using the following equation:

$${m}_{i j} = φ ( v ( {x}_{i} ) , ( v ( {x}_{j} ) ) \qquad ( 14 )$$

Subsequently, Node i then performs mean aggregation mᵢ and updates its representation via a second map, where ψ: ψ(xᵢ)=Φ(v(xᵢ),mᵢ). In Quake Neural Operator (QNO), which includes FNO and GNO, both φ and ψ are two-layer MLPs with hidden width 4Cₖ, where Cₖ is the channel dimension of the node features emitted by the k-th FNO layer preceding the k-th GNO layer. The message-passing framework in the GNO layer is permutation-invariant to accommodate irregular station layouts and combine local spatial communication with the temporal representations learned by the FNO. In architecture 300, QNO uses three GNO layers interleaved with FNO layers. In this illustrative example, QNO can be an example of neural operators 246 in FIG. 2.

To reduce the dimensionality of the shared feature representation, two different down-projection layers are used for the separated branches of the regression and classification tasks. The classification output of output 304 is generated by passing h through the down projection operator Q_{class} and applying the softmax function. On the other hand, the regression output of output 304 is generated by passing h through the down projection operator Q_{reg} to produce the predicted location and origin time for the seismic events associated with signals from input 302. In this example, both Q_{class} and Oreg consist of two layers of a fully connected neural network.

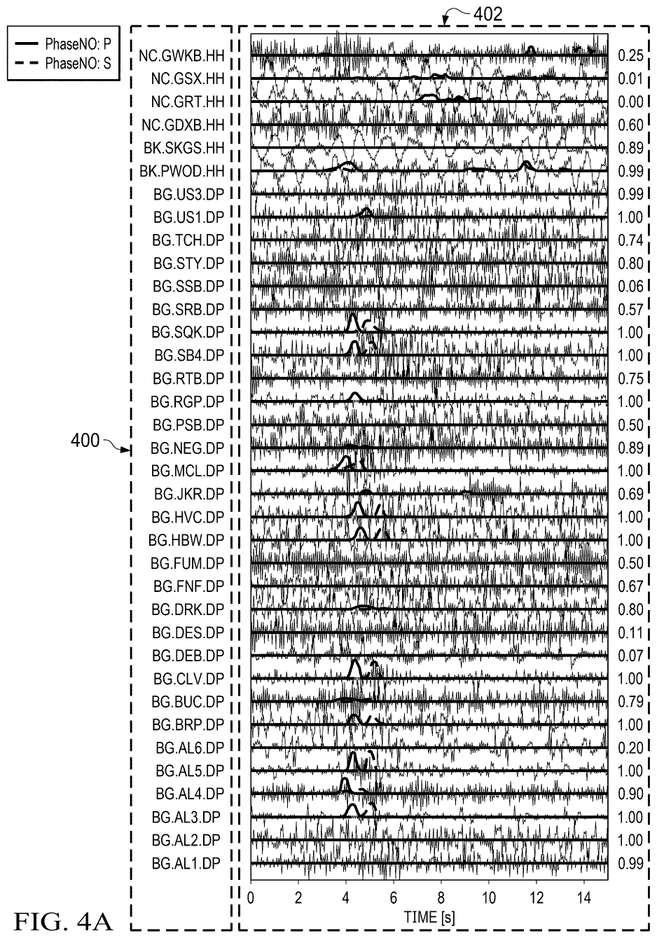

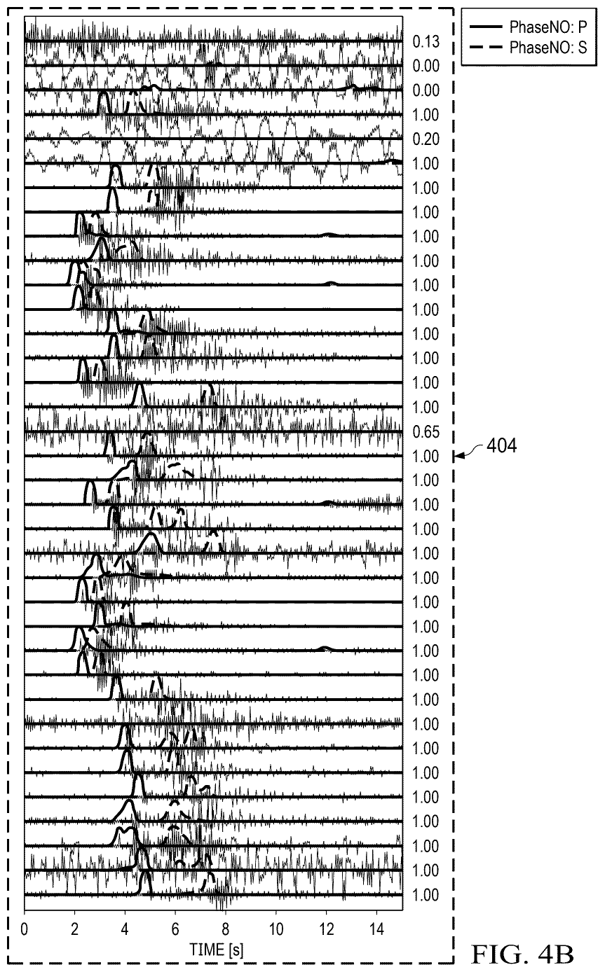

With reference now to FIGS. 4A-4B, diagrams of waveforms for two seismic events received from real stations are shown in accordance with an illustrative embodiment. In this example, data for waveforms shown in FIG. 4A-4B can be examples of dataset 226 and data 218 in FIG. 2.

In FIG. 4A, section 400 shows a list of real stations. As depicted, real stations are specialized monitoring sites that are equipped with instruments designed to detect, record, and transmit ground motion caused by seismic events. For example, real stations from the list of stations can include a number of seismometers and geophones that convert ground vibrations into electrical signals that represent the movement of the Earth overtime.

In this illustrative example, data collected from the list of real stations shown in section 400 is associated with microseismic events. In addition, detection results of the microseismic events shown in FIGS. 4A-4B are obtained using the method and architectures described in FIG. 2 and FIG. 3.

In this illustrative example, section 402 in FIG. 4A and section 404 in FIG. 4B show plots of waveforms and identified microseismic events using QNO and existing techniques. The probabilities of the microseismic events predicted by QNO are shown at the end of each waveform in section 402 and section 404. In this illustrative example, the probabilities for P-phases and S-phases of the microseismic events determined by an existing phase-picking algorithm PhaseNO can be shown in different shapes of lines.

As depicted in FIGS. 4A-4B, section 402 shows plots of waveforms for the microseismic events with a low signal-to-noise ratio while section 404 shows plots of waveforms for the microseismic events with a high signal-to-noise ratio. In this illustrative example, plots from section 404 indicate that detection results for the microseismic events are consistent with the existing techniques when a signal-to noise-ratio is high. On the other hand, plots from section 402 indicate that the method and architectures described in FIG. 2 and FIG. 3 successfully detects signals on more real stations when a signal-to noise-ratio is low. In other words, the method described in FIG. 2 and FIG. 3 is more efficient and accurate for detecting microseismic events with high noise.

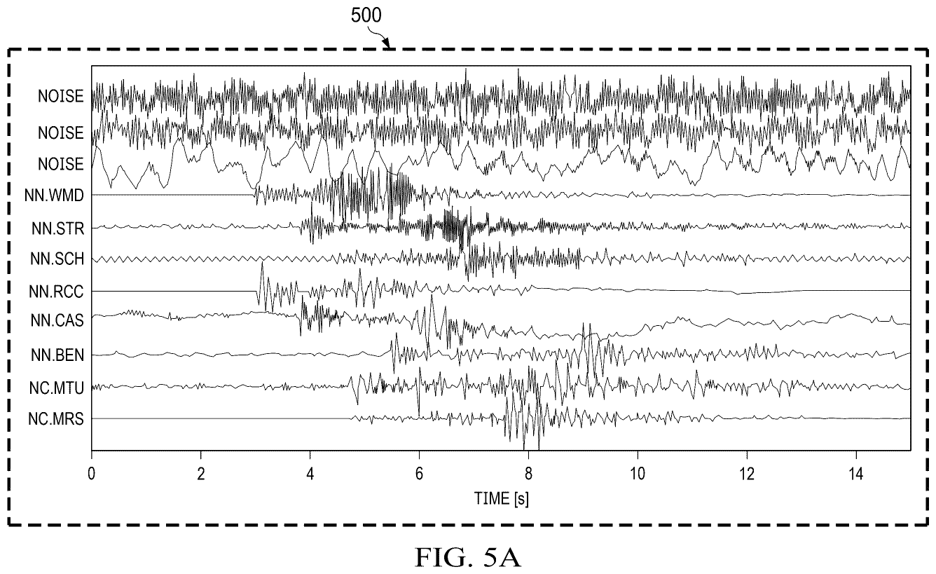

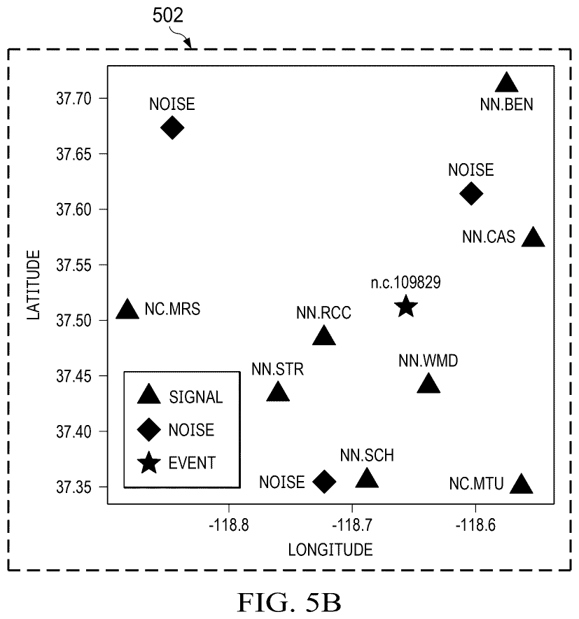

With reference now to FIGS. 5A-5B, illustrations of virtual stations and noise data assigned to the virtual stations are shown in accordance with an illustrative embodiment. In this example, the virtual stations shown in plot 502 can be an example of virtual stations 228 in FIG. 2. In addition, noise data shown in plot 500 can be examples of the set of noise data 230 in FIG. 2.

In FIG. 5B, plot 502 shows locations of real stations and virtual stations of a microseismic event for training QNO on the real stations. Plot 502 shows three virtual stations as indicated by “noise”. In this example, locations for the three virtual stations can be generated based on the locations for the real stations and the microseismic event. For example, locations for the three virtual stations can be determined using an area determined using the locations for the real stations and the microseismic event.

In this illustrative example, noise data is assigned to the three virtual stations shown in plot 502. In this illustrative example, the generated noise data is inserted into a dataset along with signal data received from the real stations for the microseismic event as shown in plot 500 in FIG. 5A. Subsequently, the dataset can be used for training a neural network such as neural network 236 in FIG. 2 to detect microseismic events with low signal-to-noise ratio.

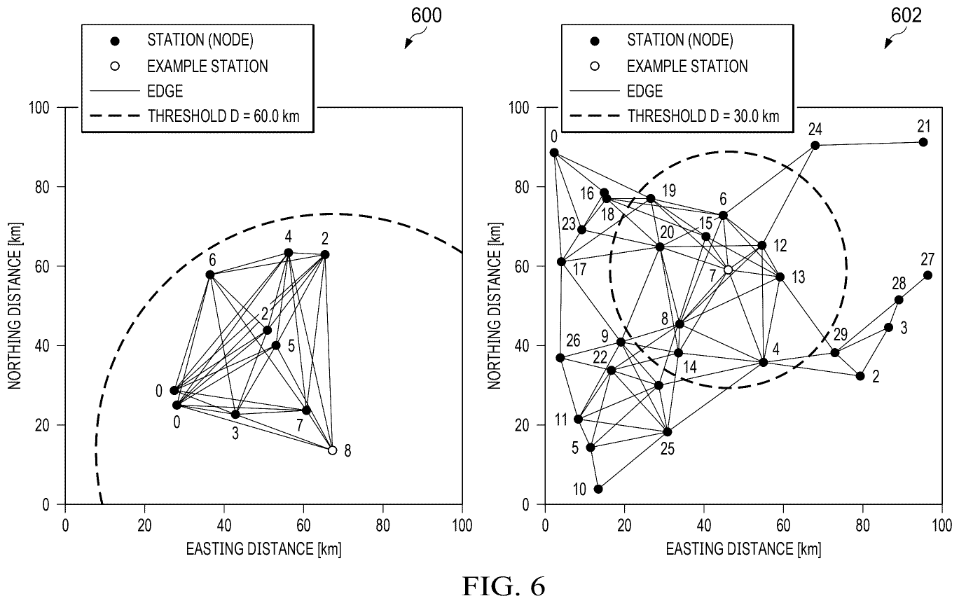

With reference now to FIG. 6, illustrations of graph construction on neural operator layers are shown in accordance with an illustrative embodiment. In this example, the graph construction shown in plot 600 and plot 602 can be achieved using second neural operator 258 in FIG. 2.

In FIG. 6, plot 600 and plot 602 show illustrations of graph constructions in neural operators such as second neural operator 258 in FIG. 2 based on geographic distance threshold “D”. In plot 600 and plot 602, each node represents a real station, and edges are established between pairs of real stations whose geographic distance is less than or equal to the geographic distance threshold.

In this illustrative example, the computational cost is largely affected by the number of edges in the graph, which is controlled by relative distance between the distance among stations and the geographic distance threshold “D”. In this example, increasing the geographic distance threshold “D” increases the number of edges on the graph, thereby raising the computational costs. For example, plot 600 shows that 10 real stations are fully connected via edges with the geographic distance threshold “D” of 60 km. However, when a large number of real stations are present, a smaller geographic distance threshold “D” of 30 km can be chosen to reduce computational cost while preserving the integrity of data collected from the real stations.

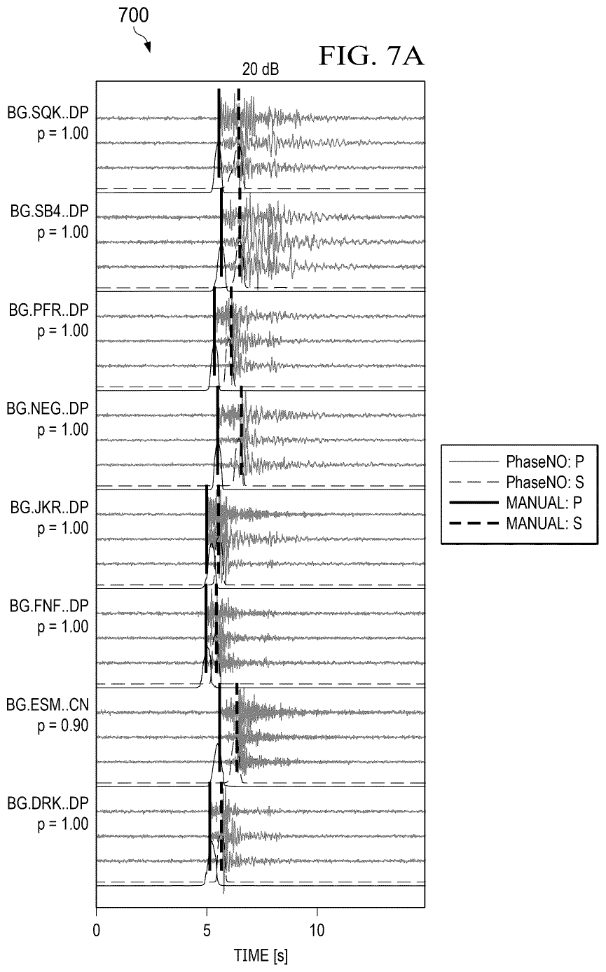

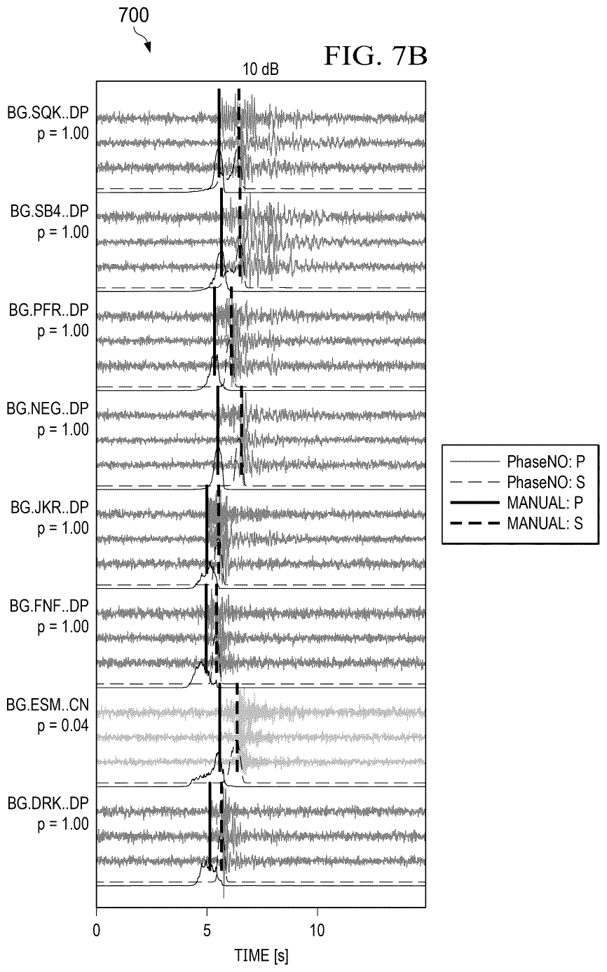

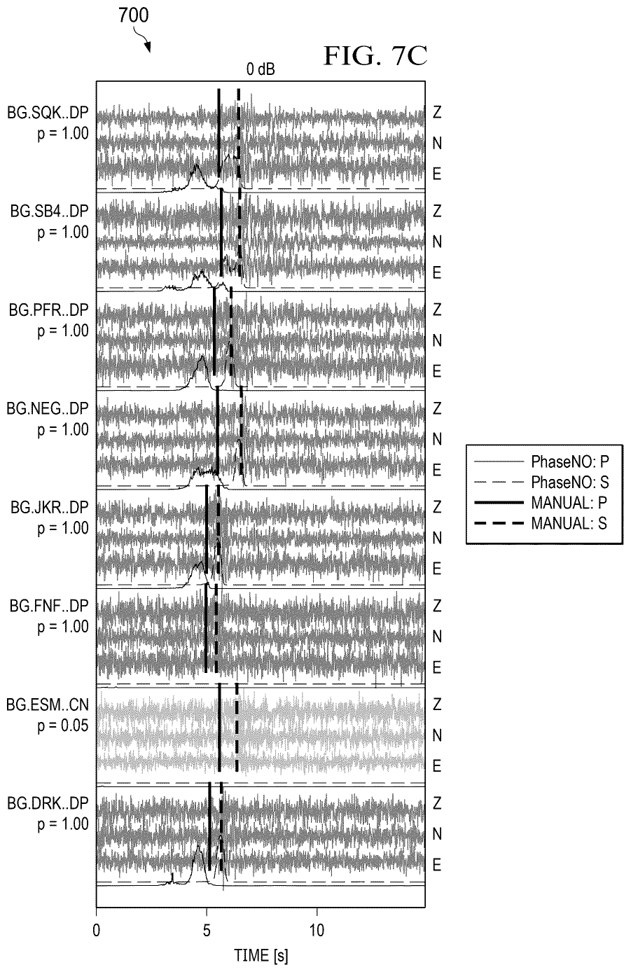

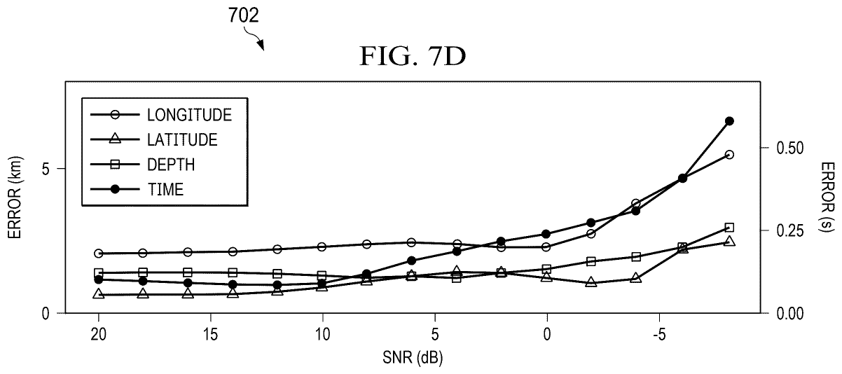

With reference now to FIGS. 7A-7D, a plot of probability for a microseismic event with different signal-to-noise ratios and a plot of location error is shown in accordance with an illustrative embodiment. In this example, the probabilities p shown in plots 700 can be determined using neural network 236 in FIG. 2.

In FIGS. 7A-7D, real noise waveforms are added to the signal data for the microseismic event to evaluate performance of neural network 236 in FIG. 2 for detecting the microseismic event. In this illustrative example, plots 700 show comparisons of probabilities predicted by neural network 236 in FIG. 2 and existing techniques at different signal-to-noise levels of 20 dB, 10 dB, and 0 dB. In this example, the probabilities predicted by neural network 236 in FIG. 2 are shown under the corresponding station names for each real station.

In addition, “Z”, “N”, and “E” shown in plots 700 indicate the vertical, north-south, and east-west components of seismic waveforms associated with the microseismic event detected at each real station. Further, plot 702 shows the location errors of neural network 236 in FIG. 2 across different signal-to-noise ratios. As depicted in FIGS. 7A-7D, neural network 236 in FIG. 2 performs much better than the existing techniques when a signal-to-noise ratio indicates high noise.

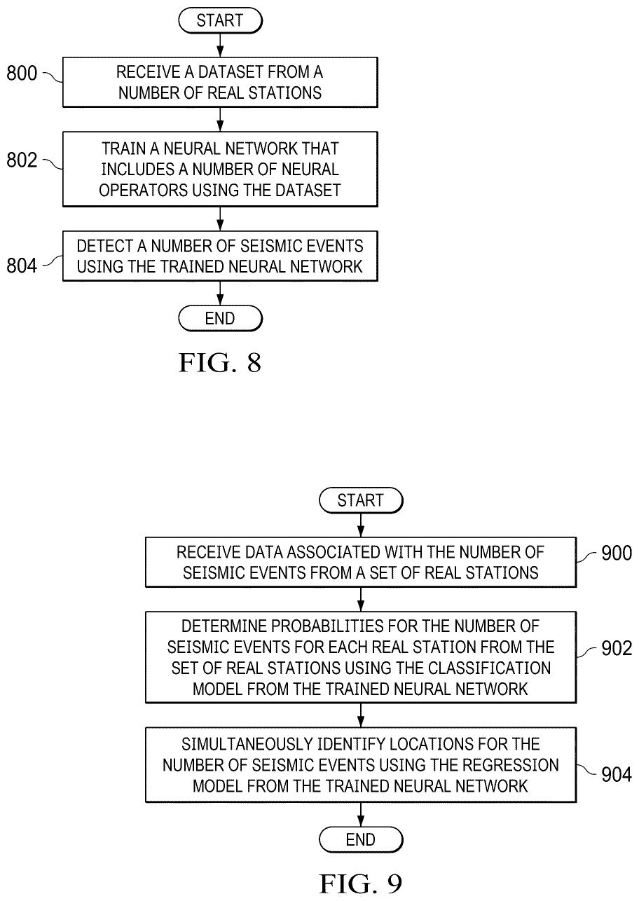

With reference now to FIG. 8, a flowchart illustrating a process for detecting seismic events using a neural network is shown in accordance with an illustrative embodiment. The process in FIG. 8 can be implemented in hardware, software, or both. When implemented in software, the process can take the form of program instructions that are run by one of more processor units located in one or more hardware devices in one or more computer systems. For example, the process can be implemented in neural network 236 in computer system 204 in FIG. 2.

The process begins by receiving a dataset from a number of real stations (step 800). In step 800, the dataset information is associated with seismic signals received from the number of real stations in a time period.

The process trains a neural network that includes a number of neural operators using the dataset (step 802). In step 802, the number of neural operators include combinations of neural operator layers for identifying temporal-spatial information associated with the seismic signals in the time period. In addition, the neural network further includes a classification model and a regression model, and the classification model and the regression model are trained using the dataset and the temporal-spatial information associated with the seismic signals in the time period.

The process detects a number of seismic events using the trained neural network (step 804). The process terminates thereafter.

With reference now to FIG. 9, a flowchart illustrating a process for detecting seismic events is shown in accordance with an illustrative embodiment. The process in this flowchart is an example of an implementation for step 804 in FIG. 8.

The process begins by receiving data associated with the number of seismic events from a set of real stations (step 900). The process determines probabilities for the number of seismic events for each real station from the set of real stations using the classification model from the trained neural network (step 902).

The process simultaneously identifies locations for the number of seismic events using the regression model from the trained neural network (step 904). The process terminates thereafter.

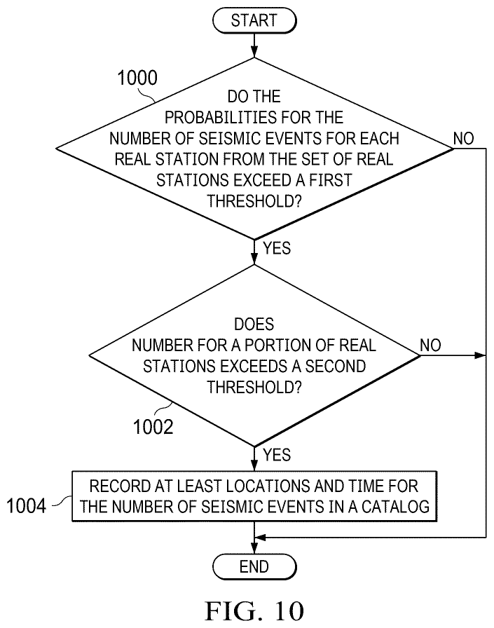

With reference now to FIG. 10, a flowchart illustrating a process for recording data for seismic events is shown in accordance with an illustrative embodiment. The process in this figure is an example of an additional step that can be performed with the steps in FIG. 8.

The process begins by determining whether the probabilities for the number of seismic events for each real station from the set of real stations exceed a first threshold (step 1000). If the probabilities for the number of seismic events for each real station from the set of real stations do not exceed the first threshold, the process terminates thereafter.

With reference again to step 1000, if the probabilities for the number of seismic events for each real station from the set of real stations exceed the first threshold, the process determines whether number for a portion of real stations exceeds a second threshold (step 1002). In this step, the portion of real stations are real stations from the set of real stations that are associated with probabilities exceeding the first threshold.

If the number for the portion of real stations does not exceed the second threshold, the process terminates thereafter. With reference again to step 1002, in response to determining that the number for the portion of real stations exceeds the second threshold, the process records at least locations and time for the number of seismic events in a catalog. The process terminates thereafter.

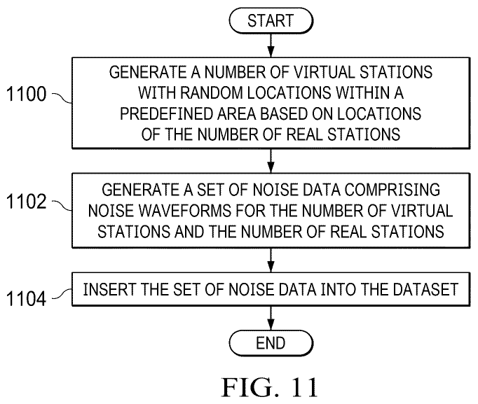

With reference now to FIG. 11, a flowchart illustrating a process for introducing noise data to the training dataset is shown in accordance with an illustrative embodiment. The process in this figure is an example of an additional step that can be performed with the steps in FIG. 8.

The process begins by generating a number of virtual stations with random locations within a predefined area based on locations of the number of real stations (step 1100). The process generates a set of noise data comprising noise waveforms for the number of virtual stations and the number of real stations (step 1102). The process inserts the set of noise data into the dataset (step 1104). The process terminates thereafter.

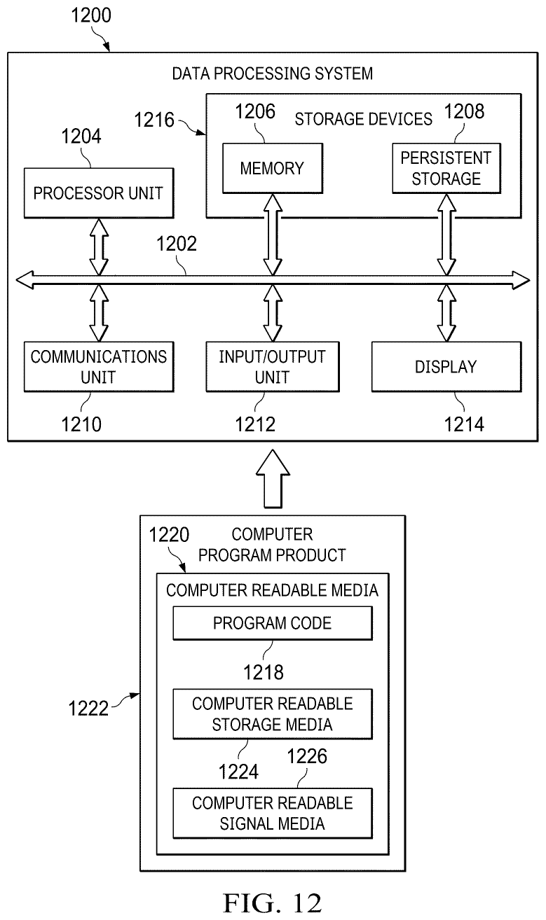

With reference now to FIG. 12, an illustration of a block diagram of a data processing system is depicted in accordance with an illustrative embodiment. Data processing system 1200 may be used to implement server computer 104 and server computer 106 and client devices 110 in FIG. 1, as well as computer system 204 in FIG. 2. In this illustrative example, data processing system 1200 includes communications framework 1202, which provides communications between processor unit 1204, memory 1206, persistent storage 1208, communications unit 1210, input/output unit 1212, and display 1214. In this example, communications framework 1202 may take the form of a bus system.

Processor unit 1204 serves to execute instructions for software that may be loaded into memory 1206. Processor unit 1204 may be a number of processors, a multi-processor core, or some other type of processor, depending on the particular implementation. In an embodiment, processor unit 1204 comprises one or more conventional general-purpose central processing units (CPUs). In an alternate embodiment, processor unit 1204 comprises one or more graphical processing units (GPUS).

Memory 1206 and persistent storage 1208 are examples of storage devices 1216. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, may be, for example, a random access memory or any other suitable volatile or non-volatile storage device. Persistent storage 1208 may take various forms, depending on the particular implementation.

For example, persistent storage 1208 may contain one or more components or devices. For example, persistent storage 1208 may be a hard drive, a flash memory, a rewritable optical disk, a rewritable magnetic tape, or some combination of the above. The media used by persistent storage 1208 also may be removable. For example, a removable hard drive may be used for persistent storage 1208. Communications unit 1210, in these illustrative examples, provides for communications with other data processing systems or devices. In these illustrative examples, communications unit 1210 is a network interface card.

Input/output unit 1212 allows for input and output of data with other devices that may be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs may be located in storage devices 1216, which are in communication with processor unit 1204 through communications framework 1202. The processes of the different embodiments may be performed by processor unit 1204 using computer-implemented instructions, which may be located in a memory, such as memory 1206.

These instructions are referred to as program code, computer-usable program code, or computer-readable program code that may be read and executed by a processor in processor unit 1204. The program code in the different embodiments may be embodied on different physical or computer-readable storage media, such as memory 1206 or persistent storage 1208.

Program code 1218 is located in a functional form on computer readable media 1220 that is selectively removable and may be loaded onto or transferred to data processing system 1200 for execution by processor unit 1204. Program code 1218 and computer readable media 1220 form computer program product 1222 in these illustrative examples. In one example, computer readable media 1220 may be computer readable storage media 1224 or computer readable signal media 1226.

In these illustrative examples, computer readable storage media 1224 is a physical or tangible storage device used to store program code 1218 rather than a medium that propagates or transmits program code 1218. Computer readable storage media 1224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1218 may be transferred to data processing system 1200 using computer readable signal media 1226. Computer readable signal media 1226 may be, for example, a propagated data signal containing program code 1218. For example, computer readable signal media 1226 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1200 are not meant to provide architectural limitations to the manner in which different embodiments may be implemented. The different illustrative embodiments may be implemented in a data processing system including components in addition to or in place of those illustrated for data processing system 1200. Other components shown in FIG. 12 can be varied from the illustrative examples shown. The different embodiments may be implemented using any hardware device or system capable of running program code 1218.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer implemented method comprising:
receiving, by a processor set, a dataset from a number of real stations, wherein the dataset comprises information associated with seismic signals in a time period;
training, by the processor set using the dataset, a neural network comprising a number of neural operators, wherein the number of neural operators comprise a combination of neural operator layers for identifying temporal-spatial information associated with the seismic signals in the time period, and wherein the neural network further comprises a classification model and a regression model, and wherein the classification model and the regression model are trained using the dataset and the temporal-spatial information associated with the seismic signals in the time period; and
detecting, by the processor set, a number of seismic events using the trained neural network.

2. The computer implemented method of claim 1, wherein the combination of neural operator layers comprises a first neural operator for processing temporal features of the seismic signals in the time period and a second neural operator for processing spatial features of the seismic signals in the time period.

3. The computer implemented method of claim 1, wherein detecting, by the processor set, the number of seismic events using the trained neural network comprises:
receiving, by the processor set, data associated with the number of seismic events from a set of real stations;
determining, by the processor set, probabilities for the number of seismic events for each real station from the set of real stations using the classification model from the trained neural network; and
simultaneously identifying, by the processor set, origin times and locations for the number of seismic events using the regression model from the trained neural network.

4. The computer implemented method of claim 3, further comprising:
determining, by the processor set, whether the probabilities for the number of seismic events for each real station from the set of real stations exceed a first threshold;
in response to determining that the probabilities for the number of seismic events for each real station from the set of real stations exceed the first threshold, determining, by the processor set, whether number for a portion of real stations exceeds a second threshold, wherein the portion of real stations are real stations from the set of real stations that are associated with probabilities exceeding the first threshold; and
in response to determining that the number for the portion of real stations exceeds the second threshold, recording, by the processor set, at least locations and time for the number of seismic events in a catalog.

5. The computer implemented method of claim 1, further comprising:
generating, by the processor set, a number of virtual stations with random locations within a predefined area based on locations of the number of real stations;
generating, by the processor set, a set of noise data comprising noise waveforms for the number of virtual stations and the number of real stations; and
inserting, by the processor set, the set of noise data into the dataset.

6. The computer implemented method of claim 1, wherein the neural network is trained using a loss function for optimizing a total loss generated based on a first loss for the classification model and a second loss for the regression model, and wherein the first loss and the second loss are weighted based on contribution of a regression task and a classification task for detecting the number of seismic events.

7. The computer implemented method of claim 1, wherein the training of the neural network is performed using segments of data from the dataset, and wherein each segment of data from the segments of data corresponds to data from a sliding time window for the dataset, wherein the sliding time window ranges from 10 seconds to 60 seconds.

8. A computer system comprising:
a processor set;
a set of one or more computer-readable storage media; and
program instructions stored on the set of one or more storage media to cause the processor set to perform operations comprising:
receiving a dataset from a number of real stations, wherein the dataset comprises information associated with seismic signals in a time period;
training a neural network comprising a number of neural operators using the dataset, wherein the number of neural operators comprise a combination of neural operator layers for identifying temporal-spatial information associated with the seismic signals in the time period, and wherein the neural network further comprises a classification model and a regression model, and wherein the classification model and the regression model are trained using the dataset and the temporal-spatial information associated with the seismic signals in the time period; and
detecting a number of seismic events using the trained neural network.

9. The computer system of claim 8, wherein the combination of neural operator layers comprises a first neural operator for processing temporal features of the seismic signals in the time period and a second neural operator for processing spatial features of the seismic signals in the time period.

10. The computer system of claim 8, wherein detecting the number of seismic events using the trained neural network comprises:
receiving data associated with the number of seismic events from a set of real stations;
determining probabilities for the number of seismic events for each real station from the set of real stations using the classification model from the trained neural network; and
simultaneously identifying locations for the number of seismic events using the regression model from the trained neural network.

11. The computer system of claim 10, wherein the operations further comprise:
determining whether the probabilities for the number of seismic events for each real station from the set of real stations exceed a first threshold;
in response to determining that the probabilities for the number of seismic events for each real station from the set of real stations exceed the first threshold, determining whether number for a portion of real stations exceeds a second threshold, wherein the portion of real stations are real stations from the set of real stations that are associated with probabilities exceeding the first threshold; and
in response to determining that the number for the portion of real stations exceeds the second threshold, recording at least locations and time for the number of seismic events in a catalog.

12. The computer system of claim 8, wherein the operations further comprise:
generating a number of virtual stations with random locations within a predefined area based on locations of the number of real stations;
generating a set of noise data comprising noise waveforms for the number of virtual stations and the number of real stations; and
inserting the set of noise data into the dataset.

13. The computer system of claim 8, wherein the neural network is trained using a loss function for optimizing a total loss generated based on a first loss for the classification model and a second loss for the regression model, and wherein the first loss and the second loss are weighted based on contribution of a regression task and a classification task for detecting the number of seismic events.

14. The computer system of claim 8, wherein the training of the neural network is performed using segments of data from the dataset, and wherein each segment of data from the segments of data corresponds to data from a sliding time window for the dataset, wherein the sliding time window ranges from 10 seconds to 60 seconds.

15. A computer program product comprising:
a set of one or more computer-readable storage media;
program instructions stored in the set of one or more computer-readable storage media to perform operations comprising:
receiving, by a processor set, a dataset from a number of real stations, wherein the dataset comprises information associated with seismic signals in a time period;
training, by the processor set using the dataset, a neural network comprising a number of neural operators, wherein the number of neural operators comprise a combination of neural operator layers for identifying temporal-spatial information associated with the seismic signals in the time period, and wherein the neural network further comprises a classification model and a regression model, and wherein the classification model and the regression model are trained using the dataset and the temporal-spatial information associated with the seismic signals in the time period; and
detecting, by the processor set, a number of seismic events using the trained neural network.

16. The computer program product of claim 15, wherein the combination of neural operator layers comprises a first neural operator for processing temporal features of the seismic signals in the time period and a second neural operator for processing spatial features of the seismic signals in the time period.

17. The computer program product of claim 15, wherein detecting, by the processor set, the number of seismic events using the trained neural network comprises:
receiving, by the processor set, data associated with the number of seismic events from a set of real stations;
determining, by the processor set, probabilities for the number of seismic events for each real station from the set of real stations using the classification model from the trained neural network; and
simultaneously identifying, by the processor set, locations for the number of seismic events using the regression model from the trained neural network.

18. The computer program product of claim 17, wherein the operations further comprise:
determining, by the processor set, whether the probabilities for the number of seismic events for each real station from the set of real stations exceed a first threshold;
in response to determining that the probabilities for the number of seismic events for each real station from the set of real stations exceed the first threshold, determining, by the processor set, whether number for a portion of real stations exceeds a second threshold, wherein the portion of real stations are real stations from the set of real stations that are associated with probabilities exceeding the first threshold; and
in response to determining that the number for the portion of real stations exceeds the second threshold, recording, by the processor set, at least locations and time for the number of seismic events in a catalog.

19. The computer program product of claim 15, wherein the operations further comprise:
generating, by the processor set, a number of virtual stations with random locations within a predefined area based on locations of the number of real stations;
generating, by the processor set, a set of noise data comprising noise waveforms for the number of virtual stations and the number of real stations; and
inserting, by the processor set, the set of noise data into the dataset.

20. The computer program product of claim 15, wherein the training of the neural network is performed using segments of data from the dataset, wherein each segment of data from the segments of data corresponds to data from a sliding time window for the dataset, wherein the sliding time window ranges from 10 seconds to 60 seconds.
